(19) United States
(12) Patent Application Publication
(10) Pub. No.: US 2009/0081099 A1
(43) Pub. Date: Mar. 26, 2009

(54) TREATMENT OF ENGINE EXHAUST USING HIGH-SILICA MOLECULAR SIEVE CHA

(76) Inventor: Lun-Teh Yuen, San Francisco, CA (US)

Correspondence Address: CHEVRON CORPORATION, P.O. BOX 6006, SAN RAMON, CA, 94583-0806, US

(21) Appl. No.: 12/330,113

(22) Filed: Dec. 8, 2008

Related U.S. Application Data
(63) Continuation of application No. 11/259,338, filed on Oct. 25, 2005.
(60) Provisional application No. 60/631,691, filed on Nov. 29, 2004.

(51) Int. Cl. B01D 53/72

(52) U.S. Cl. 423/245.3

(57) ABSTRACT

Engine exhaust is treated with a molecular sieve having the CHA crystal structure and having a mole ratio of greater than 50 of (1) an oxide selected from silicon oxide, germanium oxide or mixtures thereof to (2) an oxide selected from aluminum oxide, iron oxide, titanium oxide, gallium oxide or mixtures thereof.

This application is a continuation of application Ser. No. 11/259,338, filed Oct. 25, 2005, pending, which is an application claiming the benefit under 35 USC §119 of U.S. Provisional Application No. 60/631,691, filed Nov. 29, 2004.

### BACKGROUND

Chabazite, which has the crystal structure designated “CHA”, is a natural zeolite with the approximate formula Ca₆Al₁₂Si₂₄O₇₂. Synthetic forms of chabazite are described in “Zeolite Molecular Sieves” by D. W. Breck, published in 1973 by John Wiley & Sons. The synthetic forms reported by Breck are: zeolite “K-G”, described in J. Chem. Soc., p. 2822 (1956), Barrer et al.; zeolite D, described in British Patent No. 868,846 (1961); and zeolite R, described in U.S. Pat. No. 3,030,181, issued Apr. 17, 1962 to Milton. Chabazite is also discussed in “Atlas of Zeolite Structure Types” (1978) by W. H. Meier and D. H. Olson.

The K-G zeolite material reported in the J. Chem. Soc. Article by Barrer et al. is a potassium form having a silica:alumina mole ratio (referred to herein as “SAR”) of 2.3:1 to 4.15:1. Zeolite D reported in British Patent No. 868,846 is a sodium-potassium form having a SAR of 4.5:1 to 4.9:1. Zeolite R reported in U.S. Pat. No. 3,030,181 is a sodium form which has a SAR of 3.45:1 to 3.65:1.

Citation No. 93:66052y in Volume 93 (1980) of Chemical Abstracts concerns a Russian language article by Tsitsishrili et al. in Soobsch. Akad. Nauk. Gruz. SSR 1980, 97(3) 621-4. This article teaches that the presence of tetramethylammonium ions in a reaction mixture containing K₂O—Na₂O—SiO₂—Al₂O₃—H₂O promotes the crystallization of chabazite. The zeolite obtained by the crystallization procedure has a SAR of 4.23.

The molecular sieve designated SSZ-13, which has the CHA crystal structure, is disclosed in U.S. Pat. No. 4,544,538, issued Oct. 1, 1985 to Zones. SSZ-13 is prepared from nitrogen-containing cations derived from 1-adamantamine, 3-quinuclidinol and 2-exo-aminonorbornane. Zones discloses that the SSZ-13 of U.S. Pat. No. 4,544,538 has a composition, as-synthesized and in the anhydrous state, in terms of mole ratios of oxides as follows:
(0.5 to 1.4)R₂₀:(0 to 0.5)M₂O:W₂O₃:(greater than 5)YO2
   wherein M is an alkali metal cation, W is selected from aluminum, gallium and mixtures thereof, Y is selected from silicon, germanium and mixtures thereof, and R is an organic cation. As prepared, the silica:alumina mole ratio is typically in the range of 8:1 to about 50:1, higher mole ratios can be obtained by varying the relative ratios of reactants. It is disclosed that higher mole ratios can also be obtained by treating the SSZ-13 with chelating agents or acids to extract aluminum from the SSZ-13 lattice. It is further stated that the silica:alumina mole ratio can also be increased by using silicon and carbon halides and similar compounds.

U.S. Pat. No. 4,544,538 also discloses that the reaction mixture used to prepare SSZ-13 has a Y02/W₂O₃ mole ratio (e.g., SAR) in the range of 5:1 to 350:1. It is disclosed that use of an aqueous colloidal suspension of silica in the reaction mixture to provide a silica source allows production of SSZ-13 having a relatively high silica:alumina mole ratio.

U.S. Pat. No. 4,544,538 does not, however, disclose SSZ-13 having a silica:alumina mole ratio greater than 50.

U.S. Pat. No. 6,709,644, issued Mar. 23, 2004 to Zones et al., discloses aluminosilicate zeolites having the CHA crystal structure and having small crystallite sizes (designated SSZ-62). The reaction mixture used to prepare SSZ-62 has a SiO₂/Al₂O₃ mole ratio of 20-50. It is disclosed that the zeolite can be used for separation of gasses (e.g., separating carbon dioxide from natural gas), and in catalysts used for the reduction of oxides of nitrogen in a gas stream (e.g., automotive exhaust), converting lower alcohols and other oxygenated hydrocarbons to liquid products, and for producing dimethylamine.

M. A. Camblor, L. A. Villaescusa and M. J. Diaz-Cabanas, “Synthesis of All-Silica and High-Silica Molecular Sieves in Fluoride Media”, Topics in Catalysis, 9 (1999), pp. 59-76 discloses a method for making all-silica or high-silica zeolites, including chabazite. The chabazite is made in a reaction mixture containing fluoride and a N,N,N-trimethyl-1-adamantammonium structure directing agent. Camblor et al. does not, however, disclose the synthesis of all- or high-silica chabazite from a hydroxide-containing reaction mixture.

Gaseous waste products resulting from the combustion of hydrocarbonaceous fuels, such as gasoline and fuel oils, comprise carbon monoxide, hydrocarbons and nitrogen oxides as products of combustion or incomplete combustion, and pose a serious health problem with respect to pollution of the atmosphere. While exhaust gases from other carbonaceous fuel-burning sources, such as stationary engines, industrial furnaces, etc., contribute substantially to air pollution, the exhaust gases from automotive engines are a principal source of pollution. Because of these health problem concerns, the Environmental Protection Agency (EPA) has promulgated strict controls on the amounts of carbon monoxide, hydrocarbons and nitrogen oxides which automobiles can emit. The implementation of these controls has resulted in the use of catalytic converters to reduce the amount of pollutants emitted from automobiles.

In order to achieve the simultaneous conversion of carbon monoxide, hydrocarbon and nitrogen oxide pollutants, it has become the practice to employ catalysts in conjunction with air-to-fuel ratio control means which functions in response to a feedback signal from an oxygen sensor in the engine exhaust system. Although these three component control catalysts work quite well after they have reached operating temperature of about 300° C., at lower temperatures they are not able to convert substantial amounts of the pollutants. What this means is that when an engine and in particular an automobile engine is started up, the three component control catalyst is not able to convert the hydrocarbons and other pollutants to innocuous compounds.

Adsorbent beds have been used to adsorb the hydrocarbons during the cold start portion of the engine. Although the process typically will be used with hydrocarbon fuels, the instant invention can also be used to treat exhaust streams from alcohol fueled engines. The adsorbent bed is typically placed immediately before the catalyst. Thus, the exhaust stream is first flowed through the adsorbent bed and then through the catalyst. The adsorbent bed preferentially adsorbs hydrocarbons over water under the conditions present in the exhaust stream. After a certain amount of time, the adsorbent bed has reached a temperature (typically about 150° C.) at which the bed is no longer able to remove hydrocarbons from the exhaust stream. That is, hydrocarbons are actually desorbed from the adsorbent bed instead of being adsorbed. This regenerates the adsorbent bed so that it can adsorb hydrocarbons during a subsequent cold start.

The prior art reveals several references dealing with the use of adsorbent beds to minimize hydrocarbon emissions during a cold start engine operation. One such reference is U.S. Pat. No. 3,699,683 in which an adsorbent bed is placed after both a reducing catalyst and an oxidizing catalyst. The patentees disclose that when the exhaust gas stream is below 200° C. the gas stream is flowed through the reducing catalyst then through the oxidizing catalyst and finally through the adsorbent bed, thereby adsorbing hydrocarbons on the adsorbent bed. When the temperature goes above 200° C. the gas stream which is discharged from the oxidation catalyst is divided into a major and minor portion, the major portion being discharged directly into the atmosphere and the minor portion passing through the adsorbent bed whereby unburned hydrocarbon is desorbed and then flowing the resulting minor portion of this exhaust stream containing the desorbed unburned hydrocarbons into the engine where they are burned.

Another reference is U.S. Pat. No. 2,942,932 which teaches a process for oxidizing carbon monoxide and hydrocarbons which are contained in exhaust gas streams. The process disclosed in this patent consists of flowing an exhaust stream which is below 800° F. into an adsorption zone which adsorbs the carbon monoxide and hydrocarbons and then passing the resultant stream from this adsorption zone into an oxidation zone. When the temperature of the exhaust gas stream reaches about 800° F. the exhaust stream is no longer passed through the adsorption zone but is passed directly to the oxidation zone with the addition of excess air.

U.S. Pat. No. 5,078,979, issued Jan. 7, 1992 to Dunne, which is incorporated herein by reference in its entirety, discloses treating an exhaust gas stream from an engine to prevent cold start emissions using a molecular sieve adsorbent bed. Examples of the molecular sieve include faujasites, clinoptilolites, mordenites, chabazite, silicalite, zeolite Y, ultrastable zeolite Y, and ZSM-5.

Canadian Patent No. 1,205,980 discloses a method of reducing exhaust emissions from an alcohol fueled automotive vehicle. This method consists of directing the cool engine startup exhaust gas through a bed of zeolite particles and then over an oxidation catalyst and then the gas is discharged to the atmosphere. As the exhaust gas stream warms up it is continuously passed over the adsorption bed and then over the oxidation bed.

### SUMMARY OF THE INVENTION

This invention generally relates to a process for treating an engine exhaust stream and in particular to a process for minimizing emissions during the cold start operation of an engine. Accordingly, the present invention provides a process for treating a cold-start engine exhaust gas stream containing hydrocarbons and other pollutants consisting of flowing said engine exhaust gas stream over a molecular sieve bed which preferentially adsorbs the hydrocarbons over water to provide a first exhaust stream, and flowing the first exhaust gas stream over a catalyst to convert any residual hydrocarbons and other pollutants contained in the first exhaust gas stream to innocuous products and provide a treated exhaust stream and discharging the treated exhaust stream into the atmosphere, the molecular sieve bed characterized in that it comprises a molecular sieve having the CHA crystal structure and having a mole ratio of greater than 50 of (1) an oxide selected from silicon oxide, germanium oxide or mixtures thereof to (2) an oxide selected from aluminum oxide, iron oxide, titanium oxide, gallium oxide or mixtures thereof. In one embodiment, the molecular sieve has a mole ratio of oxide (1) to oxide (2) is 200-1500.

The present invention further provides such a process wherein the engine is an internal combustion engine, including automobile engines, which can be fueled by a hydrocarbonaceous fuel.

Also provided by the present invention is such a process wherein the molecular sieve has deposited on it a metal selected from the group consisting of platinum, palladium, rhodium, ruthenium, and mixtures thereof.

### DETAILED DESCRIPTION

The present invention relates to a process for treating engine exhaust using high-silica molecular sieves having the CHA crystal structure. As used herein, the term “high-silica” means the molecular sieve has a mole ratio of (1) silicon oxide, germanium oxide and mixtures thereof to (2) aluminum oxide, iron oxide, titanium oxide, gallium oxide and mixtures thereof of greater than 50. This includes all-silica molecular sieves in which the ratio of (1):(2) is infinity, i.e., there is essentially none of oxide (2) in the molecular sieve.

As stated this invention generally relates to a process for treating an engine exhaust stream and in particular to a process for minimizing emissions during the cold start operation of an engine. The engine consists of any internal or external combustion engine which generates an exhaust gas stream containing noxious components or pollutants including unburned or thermally degraded hydrocarbons or similar organics. Other noxious components usually present in the exhaust gas include nitrogen oxides and carbon monoxide. The engine may be fueled by a hydrocarbonaceous fuel. As used in this specification and in the appended claims, the term “hydrocarbonaceous fuel” includes hydrocarbons, alcohols and mixtures thereof. Examples of hydrocarbons which can be used to fuel the engine are the mixtures of hydrocarbons which make up gasoline or diesel fuel. The alcohols which may be used to fuel engines include ethanol and methanol. Mixtures of alcohols and mixtures of alcohols and hydrocarbons can also be used. The engine may be a jet engine, gas turbine, internal combustion engine, such as an automobile, truck or bus engine, a diesel engine or the like. The process of this invention is particularly suited for hydrocarbon, alcohol, or hydrocarbon-alcohol mixture, internal combustion engine mounted in an automobile. For convenience the description will use hydrocarbon as the fuel to exemplify the invention. The use of hydrocarbon in the subsequent description is not to be construed as limiting the invention to hydrocarbon fueled engines.

When the engine is started up, it produces a relatively high concentration of hydrocarbons in the engine exhaust gas stream as well as other pollutants. Pollutants will be used herein to collectively refer to any unburned fuel components and combustion byproducts found in the exhaust stream. For example, when the fuel is a hydrocarbon fuel, hydrocarbons, nitrogen oxides, carbon monoxide and other combustion byproducts will be found in the engine exhaust gas stream. The temperature of this engine exhaust stream is relatively cool, generally below 500° C. and typically in the range of 2000 to 400° C. This engine exhaust stream has the above characteristics during the initial period of engine operation, typically for the first 30 to 120 seconds after startup of a cold engine. The engine exhaust stream will typically contain, by volume, about 500 to 1000 ppm hydrocarbons.

The engine exhaust gas stream which is to be treated is flowed over a molecular sieve bed comprising the molecular sieve of this invention to produce a first exhaust stream. The molecular sieve is described below. The first exhaust stream which is discharged from the molecular sieve bed is now flowed over a catalyst to convert the pollutants contained in the first exhaust stream to innocuous components and provide a treated exhaust stream which is discharged into the atmosphere. It is understood that prior to discharge into the atmosphere, the treated exhaust stream may be flowed through a muffler or other sound reduction apparatus well known in the art.

The catalyst which is used to convert the pollutants to innocuous components is usually referred to in the art as a three-component control catalyst because it can simultaneously oxidize any residual hydrocarbons present in the first exhaust stream to carbon dioxide and water, oxidize any residual carbon monoxide to carbon dioxide and reduce any residual nitric oxide to nitrogen and oxygen. In some cases the catalyst may not be required to convert nitric oxide to nitrogen and oxygen, e.g., when an alcohol is used as the fuel. In this case the catalyst is called an oxidation catalyst. Because of the relatively low temperature of the engine exhaust stream and the first exhaust stream, this catalyst does not function at a very high efficiency, thereby necessitating the molecular sieve bed.

When the molecular sieve bed reaches a sufficient temperature, typically about 150-200° C., the pollutants which are adsorbed in the bed begin to desorb and are carried by the first exhaust stream over the catalyst. At this point the catalyst has reached its operating temperature and is therefore capable of fully converting the pollutants to innocuous components.

The adsorbent bed used in the instant invention can be conveniently employed in particulate form or the adsorbent can be deposited onto a solid monolithic carrier. When particulate form is desired, the adsorbent can be formed into shapes such as pills, pellets, granules, rings, spheres, etc. In the employment of a monolithic form, it is usually most convenient to employ the adsorbent as a thin film or coating deposited on an inert carrier material which provides the structural support for the adsorbent. The inert carrier material can be any refractory material such as ceramic or metallic materials. It is desirable that the carrier material be unreactive with the adsorbent and not be degraded by the gas to which it is exposed. Examples of suitable ceramic materials include sillimanite, petalite, cordierite, mullite, zircon, zircon mullite, spondumene, alumina-titanate, etc. Additionally, metallic materials which are within the scope of this invention include metals and alloys as disclosed in U.S. Pat. No. 3,920,583 which are oxidation resistant and are otherwise capable of withstanding high temperatures.

The carrier material can best be utilized in any rigid unitary configuration which provides a plurality of pores or channels extending in the direction of gas flow. It is preferred that the configuration be a honeycomb configuration. The honeycomb structure can be used advantageously in either unitary form, or as an arrangement of multiple modules. The honeycomb structure is usually oriented such that gas flow is generally in the same direction as the cells or channels of the honeycomb structure. For a more detailed discussion of monolithic structures, refer to U.S. Pat. Nos. 3,785,998 and 3,767,453.

The molecular sieve is deposited onto the carrier by any convenient way well known in the art. A preferred method involves preparing a slurry using the molecular sieve and coating the monolithic honeycomb carrier with the slurry. The slurry can be prepared by means known in the art such as combining the appropriate amount of the molecular sieve and a binder with water. This mixture is then blended by using means such as sonification, milling, etc. This slurry is used to coat a monolithic honeycomb by dipping the honeycomb into the slurry, removing the excess slurry by draining or blowing out the channels, and heating to about 100° C. If the desired loading of molecular sieve is not achieved, the above process may be repeated as many times as required to achieve the desired loading.

Instead of depositing the molecular sieve onto a monolithic honeycomb structure, one can take the molecular sieve and form it into a monolithic honeycomb structure by means known in the art.

The adsorbent may optionally contain one or more catalytic metals dispersed thereon. The metals which can be dispersed on the adsorbent are the noble metals which consist of platinum, palladium, rhodium, ruthenium, and mixtures thereof. The desired noble metal may be deposited onto the adsorbent, which acts as a support, in any suitable manner well known in the art. One example of a method of dispersing the noble metal onto the adsorbent support involves impregnating the adsorbent support with an aqueous solution of a decomposable compound of the desired noble metal or metals, drying the adsorbent which has the noble metal compound dispersed on it and then calcining in air at a temperature of about 400° to about 500° C. for a time of about 1 to about 4 hours. By decomposable compound is meant a compound which upon heating in air gives the metal or metal oxide. Examples of the decomposable compounds which can be used are set forth in U.S. Pat. No. 4,791,091 which is incorporated by reference. Preferred decomposable compounds are chloroplatinic acid, rhodium trichloride, chloropalladic acid, hexachloroiridate (IV) acid and hexachlororuthenate. It is preferable that the noble metal be present in an amount ranging from about 0.01 to about 4 weight percent of the adsorbent support. Specifically, in the case of platinum and palladium the range is 0.1 to 4 weight percent, while in the case of rhodium and ruthenium the range is from about 0.01 to 2 weight percent.

These catalytic metals are capable of oxidizing the hydrocarbon and carbon monoxide and reducing the nitric oxide components to innocuous products. Accordingly, the adsorbent bed can act both as an adsorbent and as a catalyst.

The catalyst which is used in this invention is selected from any three component control or oxidation catalyst well known in the art. Examples of catalysts are those described in U.S. Pat. Nos. 4,528,279; 4,791,091; 4,760,044; 4,868,148; and 4,868,149, which are all incorporated by reference. Preferred catalysts well known in the art are those that contain platinum and rhodium and optionally palladium, while oxidation catalysts usually do not contain rhodium. Oxidation catalysts usually contain platinum and/or palladium metal. These catalysts may also contain promoters and stabilizers such as barium, cerium, lanthanum, nickel, and iron. The noble metals promoters and stabilizers are usually deposited on a support such as alumina, silica, titania, zirconia, alumino silicates, and mixtures thereof with alumina being preferred. The catalyst can be conveniently employed in particulate form or the catalytic composite can be deposited on a solid monolithic carrier with a monolithic carrier being preferred. The particulate form and monolithic form of the catalyst are prepared as described for the adsorbent above.

High-silica CHA molecular sieves can be suitably prepared from an aqueous reaction mixture containing sources of an alkali metal or alkaline earth metal oxide; sources of an oxide of silicon, germanium or mixtures thereof; optionally, sources of aluminum oxide, iron oxide, titanium oxide, gallium oxide and mixtures thereof; and a cation derived from 1-adamantamine, 3-quinuclidinol or 2-exo-aminonorbornane. The mixture should have a composition in terms of mole ratios falling within the ranges shown in Table A below:

TABLE A

| YO₂/WₐO_{b} | 220-∞ (preferably 350-5500) |
|---|---|
| OH—/YO₂ | 0.19-0.52 |
| Q/YO₂ | 0.15-0.25 |
| M_{2/n}O/YO₂ | 0.04-0.10 |
| H₂O/YO₂ | 10-50 |

wherein Y is silicon, germanium or mixtures thereof, W is aluminum, iron, titanium, gallium or mixtures thereof, M is an alkali metal or alkaline earth metal, n is the valence of M (i.e., 1 or 2) and Q is a cation derived from 1-adamantamine, 3-quinuclidinol or 2-exo-aminonorbornane.

The cation derived from 1-adamantamine can be a N,N,N-trialkyl-1-adamantammonium cation which has the formula:

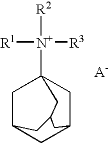

where R¹, R², and R³ are each independently a lower alkyl, for example methyl. The cation is associated with an anion, A⁻, which is not detrimental to the formation of the molecular sieve. Representative of such anions include halogens, such as chloride, bromide and iodide; hydroxide; acetate; sulfate and carboxylate. Hydroxide is the preferred anion. It may be beneficial to ion exchange, for example, a halide for hydroxide ion, thereby reducing or eliminating the alkali metal or alkaline earth metal hydroxide required.

The cation derived from 3-quinuclidinol can have the formula:

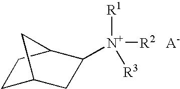

where R¹, R², R³ and A are as defined above.

The cation derived from 2-exo-aminonorbornane can have the formula:

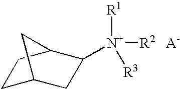

where R¹, R², R³ and A are as defined above.

The reaction mixture is prepared using standard molecular sieve preparation techniques. Typical sources of silicon oxide include fumed silica, silicates, silica hydrogel, silicic acid, colloidal silica, tetra-alkyl orthosilicates, and silica hydroxides. Examples of such silica sources include CAB-O-SIL M5 fumed silica and Hi-Sil hydrated amorphous silica, or mixtures thereof. Typical sources of aluminum oxide include aluminates, alumina, hydrated aluminum hydroxides, and aluminum compounds such as AlCl₃ and Al₂(SO₄)₃. Sources of other oxides are analogous to those for silicon oxide and aluminum oxide.

It has been found that seeding the reaction mixture with CHA crystals both directs and accelerates the crystallization, as well as minimizing the formation of undesired contaminants. In order to produce pure phase high-silica CHA crystals, seeding may be required. When seeds are used, they can be used in an amount that is about 2-3 wt. % based on the weight of YO₂.

The reaction mixture is maintained at an elevated temperature until CHA crystals are formed. The temperatures during the hydrothermal crystallization step are typically maintained from about 120° C. to about 160° C. It has been found that a temperature below 160° C., e.g., about 120° C. to about 140° C., is useful for producing high-silica CHA crystals without the formation of secondary crystal phases.

In one embodiment, the reaction mixture contains seeds of CHA crystals and the reaction mixture is maintained at a temperature of less than 160° C., for example 120° C. to 140° C.

The crystallization period is typically greater than 1 day and preferably from about 3 days to about 7 days. The hydrothermal crystallization is conducted under pressure and usually in an autoclave so that the reaction mixture is subject to autogenous pressure. The reaction mixture can be stirred, such as by rotating the reaction vessel, during crystallization.

Once the high-silica CHA crystals have formed, the solid product is separated from the reaction mixture by standard mechanical separation techniques such as filtration. The crystals are water-washed and then dried, e.g., at 90° C. to 150° C. for from 8 to 24 hours, to obtain the as-synthesized crystals. The drying step can be performed at atmospheric or subatmospheric pressures.

The high-silica CHA can be made with a mole ratio of YO₂/W_{c}O_{d} of ∞, i.e., there is essentially no W_{c}O_{d} present in the CHA. In this case, the CHA would be an all-silica material or a germanosilicate. Thus, in a typical case where oxides of silicon and aluminum are used, CHA can be made essentially aluminum free, i.e., having a silica to alumina mole ratio of ∞. A method of increasing the mole ratio of silica to alumina is by using standard acid leaching or chelating treatments. The high-silica CHA can also be made by first preparing a borosilicate CHA and then removing the boron. The boron can be removed by treating the borosilicate CHA with acetic acid at elevated temperature (as described in Jones et al., Chem. Mater., 2001, 13, pp. 1041-1050) to produce an all-silica version of CHA.

The high-silica CHA molecular sieve has a composition, as-synthesized and in the anhydrous state, in terms of mole ratios of oxides as indicated in Table B below:

TABLE B
As-Synthesized High-Silica CHA Composition

| YO₂/W_{c}O_{d} | Greater than 50-∞ |
|---|---|
| | (e.g., >50-1500 or 200-1500) |
| M_{2/n}O/YO₂ | 0.04-0.15 |
| Q/YO₂ | 0.15-0.25 |

wherein Y is silicon, germanium or mixtures thereof, W is aluminum, iron, titanium, gallium or mixtures thereof; c is 1 or 2; d is 2 when c is 1 (i.e., W is tetravalent) or d is 3 or 5 when c is 2 (i.e., d is 3 when W is trivalent or 5 when W is pentavalent); M is an alkali metal cation, alkaline earth metal cation or mixtures thereof; n is the valence of M (i.e., 1 or 2); and Q is a cation derived from 1-adamantamine, 3-quinuclidinol or 2-exo-aminonorbornane. The as-synthesized material does not contain fluoride.

The present invention also provides a molecular sieve having the CHA crystal structure and having a mole ratio of greater than 50 to 1500 of (1) an oxide selected from silicon oxide, germanium oxide or mixtures thereof to (2) an oxide selected from aluminum oxide, iron oxide, titanium oxide, gallium oxide or mixtures thereof. In one embodiment, the molecular sieve has a mole ratio of oxide (1) to oxide (2) is 200-1500.

High-silica CHA molecular sieves can be used as-synthesized or can be thermally treated (calcined). By “thermal treatment” is meant heating to a temperature from about 200° C. to about 820° C., either with or without the presence of steam. Usually, it is desirable to remove the alkali metal cation by ion exchange and replace it with hydrogen, ammonium, or any desired metal ion. Thermal treatment including steam helps to stabilize the crystalline lattice from attack by acids.

The high silica CHA molecular sieves, as-synthesized, have a crystalline structure whose X-ray powder diffraction (“XRD”) pattern shows the following characteristic lines:

TABLE I
As-Synthesized High Silica CHA XRD

| 2 Theta^{(a)} | d-spacing (Angstroms) | Relative Intensity^{(b)} |
|---|---|---|
| 9.64 | 9.17 | S |
| 14.11 | 6.27 | M |
| 16.34 | 5.42 | VS |
| 17.86 | 4.96 | M |
| 21.03 | 4.22 | VS |
| 25.09 | 3.55 | S |
| 26.50 | 3.36 | W-M |
| 30.96 | 2.89 | W |
| 31.29 | 2.86 | M |
| 31.46 | 2.84 | W |

^{(a)}±0.10
^{(b)}The X-ray patterns provided are based on a relative intensity scale in which the strongest line in the X-ray pattern is assigned a value of 100: W(weak) is less than 20; M(medium) is between 20 and 40; S(strong) is between 40 and 60; VS(very strong) is greater than 60.

Table IA below shows the X-ray powder diffraction lines for as-synthesized high silica CHA including actual relative intensities.

TABLE IA
As-Synthesized High Silica CHA XRD

| 2 Theta^{(a)} | d-spacing (Angstroms) | Relative Intensity(%) |
|---|---|---|
| 9.64 | 9.17 | 50.8 |
| 13.16 | 6.72 | 4.4 |
| 14.11 | 6.27 | 23.1 |
| 16.34 | 5.42 | 82.4 |
| 17.86 | 4.96 | 21.7 |
| 19.34 | 4.59 | 6.1 |
| 21.03 | 4.22 | 100 |
| 22.24 | 3.99 | 11.0 |
| 22.89 | 3.88 | 10.7 |
| 23.46 | 3.79 | 4.9 |
| 25.09 | 3.55 | 43.1 |
| 26.50 | 3.36 | 19.5 |
| 28.25 | 3.16 | 4.7 |
| 28.44 | 3.14 | 1.5 |
| 30.14 | 2.96 | 3.2 |
| 30.96 | 2.89 | 14.3 |
| 31.29 | 2.86 | 37.5 |
| 31.46 | 2.84 | 12.0 |
| 33.01 | 2.71 | 1.8 |
| 33.77 | 2.65 | 1.9 |
| 34.05 | 2.63 | 0.2 |
| 35.28 | 2.54 | 3.6 |
| 35.69 | 2.51 | 0.7 |
| 36.38 | 2.47 | 5.8 |
| 39.22 | 2.30 | 1.0 |
| 39.81 | 2.26 | 0.8 |

^{(a)}±0.10

After calcination, the high silica CHA molecular sieves have a crystalline structure whose X-ray powder diffraction pattern include the characteristic lines shown in Table II:

TABLE II
Calcined High Silica CHA XRD

| 2 Theta^{(a)} | d-spacing (Angstroms) | Relative Intensity |
|---|---|---|
| 9.65 | 9.2 | VS |
| 13.08 | 6.76 | M |
| 16.28 | 5.44 | W |
| 18.08 | 4.90 | W |
| 20.95 | 4.24 | M |
| 25.37 | 3.51 | W |
| 26.36 | 3.38 | W |
| 31.14 | 2.87 | M |
| 31.61 | 2.83 | W |
| 35.10 | 2.55 | W |

^{(a)}±0.10

Table IIA below shows the X-ray powder diffraction lines for calcined high silica CHA including actual relative intensities.

TABLE IIA
Calcined High Silica CHA XRD

| 2 Theta^{(a)} | d-spacing (Angstroms) | Relative Intensity(%) |
|---|---|---|
| 9.65 | 9.2 | 100 |
| 13.08 | 6.76 | 29.3 |
| 14.21 | 6.23 | 3.9 |
| 16.28 | 5.44 | 15.2 |
| 18.08 | 4.90 | 16.1 |
| 19.37 | 4.58 | 2.3 |
| 20.95 | 4.24 | 36.8 |
| 22.38 | 3.97 | 1.9 |
| 22.79 | 3.90 | 1.9 |
| 23.44 | 3.79 | 1.5 |
| 25.37 | 3.51 | 14.1 |
| 26.36 | 3.38 | 9.5 |
| 28.12 | 3.17 | 2.0 |
| 28.65 | 3.11 | 1.9 |
| 30.07 | 2.97 | 1.0 |
| 31.14 | 2.87 | 22.0 |
| 31.36 | 2.85 | 2.9 |
| 31.61 | 2.83 | 9.3 |
| 32.14 | 2.78 | 0.9 |
| 32.90 | 2.72 | 1.0 |
| 34.03 | 2.63 | 2.1 |
| 35.10 | 2.55 | 4.3 |
| 36.64 | 2.45 | 3.3 |
| 39.29 | 2.29 | 1.3 |
| 40.40 | 2.23 | 2.6 |

^{(a)}±0.10

The X-ray powder diffraction patterns were determined by standard techniques. The radiation was the K-alpha/doublet of copper and a scintillation counter spectrometer with a strip-chart pen recorder was used. The peak heights I and the positions, as a function of 2 Theta where Theta is the Bragg angle, were read from the spectrometer chart. From these measured values, the relative intensities, 100×I/Io, where Io is the intensity of the strongest line or peak, and d, the interplanar spacing in Angstroms corresponding to the recorded lines, can be calculated.

Variations in the diffraction pattern can result from variations in the mole ratio of oxides from sample to sample. The molecular sieve produced by exchanging the metal or other cations present in the molecular sieve with various other cations yields a similar diffraction pattern, although there can be shifts in interplanar spacing as well as variations in relative intensity. Calcination can also cause shifts in the X-ray diffraction pattern. Also, the symmetry can change based on the relative amounts of boron and aluminum in the crystal structure. Notwithstanding these perturbations, the basic crystal lattice structure remains unchanged.

High-silica CHA molecular sieves are useful in useful in adsorption, in catalysts useful in converting methanol to olefins, synthesis of amines (such as dimethylamine), in the reduction of oxides of nitrogen in gasses (such as automobile exhaust), and in gas separation.

### EXAMPLES

### Examples 1-16

High silica CHA is synthesized by preparing the gel compositions, i.e., reaction mixtures, having the compositions, in terms of mole ratios, shown in the table below. The resulting gel is placed in a Parr bomb reactor and heated in an oven at the temperature indicated below while rotating at the speed indicated below. Products are analyzed by X-ray diffraction (XRD) and found to be high silica molecular sieves having the CHA structure. The source of silicon oxide is Cabosil M-5 fumed silica or HiSil 233 amorphous silica (0.208 wt. % alumina). The source of aluminum oxide is Reheis F 2000 alumina.

| | | | | | | | | | Product | Product |
|---|---|---|---|---|---|---|---|---|---|---|
| | SiO₂/ | OH—/ | SDA¹/ | Na+/ | H₂O/ | Wt. % | Rxn. | | Actual | Estimated |
| Ex. No. | Al₂O₃ | SiO₂ | SiO₂ | SiO₂ | SiO₂ | Seed | Cond.² | Yield (g) | SiO₂/Al₂O₃ | SiO₂/Al₂O₃ |
| 1 | 1,731⁴ | 0.34 | 0.18 | 0.16 | 15.62 | 4.12 | 120/43/6 | 0.08 | | 95 |
| 2 | 1,907 | 0.36 | 0.18 | 0.19 | 15.68 | 4.12 | 120/43/8 | 0.10 | | 131 |
| 3 | 224³ | 0.19 | 0.18 | 0.01 | 16.59 | 4.02 | 120/43/7 | 13.39 | 166 | |
| 4 | 221³ | 0.36 | 0.18 | 0.18 | 16.16 | 4.15 | 120/43/7 | 1.29 | 167 | |
| 5 | 2,485⁴ | 0.36 | 0.18 | 0.18 | 16.03 | 4.12 | 120/43/7 | 0.11 | | 188 |
| 6 | 296⁴ | 0.37 | 0.18 | 0.19 | 15.84 | 4.16 | 120/43/6 | 0.98 | | 201 |
| 7 | 1,731 | 0.36 | 0.18 | 0.19 | 15.68 | 4.12 | 120/43/5 | 0.18 | | 214 |
| 8 | 407⁴ | 0.40 | 0.21 | 0.19 | 44.39 | 2.01 | 160/43/4 | 0.53 | | 290 |
| 9 | 435 | 0.42 | 0.21 | 0.21 | 45.81 | 4.02 | 150/100/4 | 15.03 | 296 | |
| 10 | 982⁴ | 0.42 | 0.31 | 0.11 | 28.03 | 2.78 | 140/43/5 | 0.38 | | 346 |
| 11 | 350³ | 0.36 | 0.18 | 0.18 | 16.16 | 4.15 | 120/43/5 | 1.43 | | 347 |
| 12 | 1,731⁴ | 0.36 | 0.18 | 0.19 | 15.68 | 4.12 | 12C/43/6 | 0.33 | 584 | |
| 13 | 980⁴ | 0.33 | 0.25 | 0.08 | 22.70 | 2.78 | 140/43/5 | 0.92 | | 628 |
| 14 | 4,135 | 0.36 | 0.17 | 0.19 | 15.86 | 5.01 | 120/200/5 | 6.90 | 682 | |
| 15 | 5,234 | 0.33 | 0.15 | 0.18 | 11.62 | 4.7 | 120/43/4 | 0.3 | | 783 |
| 16 | 4,104 | 0.37 | 0.18 | 0.19 | 18.11 | 5.01 | 120/75/5 | 7.37 | 1,394 | |

1 ¹SDA = Cation derived from 1-adamantamine
2 ²° C./RPM/Days
3 ³SiO₂ source = Hi Sil
4 ⁴SiO₂ source = CAB-O-SIL
5
6 The product of each reaction is a crystalline molecular sieve having the CHA structure.

What is claimed is:

1. A process for treating a cold-start engine exhaust gas stream containing hydrocarbons and other pollutants, comprising:
flowing the engine exhaust gas stream over a molecular sieve bed which preferentially adsorbs the hydrocarbons over water to provide a first exhaust stream; and
flowing the first exhaust gas stream over a catalyst to convert residual hydrocarbons contained in the first exhaust gas stream;
wherein the molecular sieve bed comprises a molecular sieve having:
(a) a CHA crystal structure;
(b) a mole ratio of greater than 50 of (1) an oxide selected from the group consisting of silicon oxide, germanium oxide and mixtures thereof to (2) an oxide selected from the group consisting of aluminum oxide, iron oxide, titanium oxide, gallium oxide and mixtures thereof;
(c) after calcination, an X-ray diffraction pattern substantially as shown in the following Table:

| 2 Theta | d-spacinq (Anqstroms) | Relative Intensity |
|---|---|---|
| 9.65 ± 0.10 | 9.2 | VS |
| 13.08 ± 0.10 | 6.76 | M |
| 16.28 ± 0.10 | 5.44 | W |
| 18.08 ± 0.10 | 4.90 | W |
| 20.95 ± 0.10 | 4.24 | M |
| 25.37 ± 0.10 | 3.51 | W |
| 26.36 ± 0.10 | 3.38 | W |
| 31.14 ± 0.10 | 2.87 | M |
| 31.61 ± 0.10 | 2.83 | W |
| 35.10 ± 0.10 | 2.55 | W |

(d) a composition, as-synthesized and in the anhydrous state, in terms of mole ratios, as follows:

| YO₂/W_{c}O_{d} | greater than 50 |
|---|---|
| M_{2/n}O/YO₂ | 0.04-0.15 |
| Q/YO₂ | 0.15-0.25 |

wherein:
(1) Y is selected from the group consisting of silicon, germanium and mixtures thereof, W is selected from the group consisting of aluminum, iron, titanium, gallium and mixtures thereof;
(2) c is 1 or 2, and d is 2 when c is 1 or d is 3 or 5 when c is 2;
(3) M is selected from the group consisting of alkali metal cations, alkaline earth metal cations and mixtures thereof, and n is the valence of M; and
(4) Q is a cation derived from 1-adamantamine, 3-quinuclidinol or 2-exo-aminonorbornane.

2. The process of claim 1, wherein the molecular sieve has a mole ratio of oxide (1) to oxide (2) of 50-1500.

3. The process of claim 1, wherein the molecular sieve has a mole ratio of oxide (1) to oxide (2) of 200-1500.

4. The process of claim 1, wherein Y is Si and W is Al.

4. The process of claim 1, wherein Y is Si and W is B.

5. The process of claim 1, wherein the molecular sieve comprises essentially all silicon oxide.

6. The process of claim 1, wherein the engine is an internal combustion engine.

7. The process of claim 6, wherein the internal combustion engine is an automobile engine.

8. The process of claim 1, wherein the engine is fueled by a hydrocarbonaceous fuel.

9. The process of claim 1, wherein the molecular sieve has deposited on it a metal selected from the group consisting of platinum, palladium, rhodium, ruthenium, and mixtures thereof.

10. The process of claim 9, wherein the metal is platinum.

11. The process of claim 9, wherein the metal is palladium.

12. The process of claim 9, wherein the metal is a mixture of platinum and palladium.
